(19) United States
(12) Patent Application Publication
(10) Pub. No.: US 2025/0304820 A1
(43) Pub. Date: Oct. 2, 2025

(54) METHOD

(71) Applicant: Green Sol-Gel Ltd, Sittingbourne Kent (GB)

(72) Inventor: Fanya Ismail, Sittingbourne Kent (GB)

(21) Appl. No.: 18/865,067

(22) PCT Filed: May 12, 2023
(86) PCT No.: PCT/GB2023/051260

§ 371 Date: Nov. 12, 2024

(30) Foreign Application Priority Data
May 13, 2022 (GB) 2207061.9

(51) Int. Cl. C09D 189/00; C09D 15/00; C09D 193/02; D21H 19/12

(52) U.S. Cl. CPC C09D 189/00; C09D 15/00; C09D 193/02; D21H 19/12

(57) ABSTRACT

A method for forming a water, oil, and/or gas resistant and/or impermeable product. The method includes (a) coating a product with a composition, the composition including: a protein, wherein the protein, is a plant-derived protein, an animal-derived protein, a fungus-derived protein, or any combination thereof; and/or shellac; and (b) heating the coated product. The coated product may be heated to temperatures in excess of the ignition temperature of the uncoated product and/or in excess of the thermal degradation temperature of the protein and/or shellac (e.g. to temperatures between 200° C. and 300° C.) without damaging the coated product. Water, oil, and/or gas resistant and/or impermeable products formed by the method may includes cellulose-based products such as a paper-, cardboard- or wood-based products. The products may form part of or all of a container for use in the food and beverages industry or an item of cutlery.

### INTRODUCTION

The present invention relates to a method for forming a water, oil, and/or gas resistant and/or impermeable product and products formed by said method.

Commercial products in many applications benefit from water, oil, and/or gas resistance and/or impermeability. For example, paper, cardboard and other materials that are commonly used as packaging for commercial products will often include such a wall, barrier, or container portion for applications in which liquids or gasses must be retained within, or kept outside of, the product in question. The passage of water, oil, gas, and other fluids has traditionally been controlled by using functionalised coatings utilising impermeable plastic materials or composites. In many industries, such as the food and beverage industry, plastics may be applied to otherwise permeable media to facilitate the retention of liquid products within a particular packaging item. Similar methods may also be used to prevent the ingress of fluid into an item that may become compromised by exposure to water, air or other fluids. In an example, some paper or cardboard products are subjected to a method called internal sizing or surface sizing wherein hydrocarbon-derived materials such as microplastics are used to modify the porosity, adsorption, wear resistance, or other properties of the material. The materials used to produce existing functionalised coatings are generally produced from feedstocks with an associated environmental cost. For example, plastic materials are generally sourced from hydrocarbon feedstocks whereas metallic coatings may originate from mining activities. The materials or chemicals used to manufacture such functional coatings and the associated by-products may also be toxic. Some materials may also degrade over time to produce particulates such as microplastics. Additionally, many such materials may release potentially harmful species through use. For example, per- and polyfluoroalkyl substances, which have been linked to public health risks, have been used to form water-resistant materials since the 1940s. Consequently, there are ongoing health and environmental concerns in relation to many common materials found in both consumer products and the industrial environment that are used to impart water, oil, and/or gas resistance and/or impermeability to commercial products. In addition, although wood may be used as a plastics replacement in some applications (e.g. disposable cutlery), the relative strength of the wood before and after exposure to water and/or oil requires a greater thickness to be used than would otherwise be desirable. Consequently, the potential for wood to be used as a plastics replacement is limited by the properties of the wood.

The inventor of the present invention has found a novel and unexpected method for forming water, oil, and/or gas resistant and/or impermeable products, which products provide a non-toxic and practical alternative to commonly used products comprising plastics or formed from plastics. In particular, the products formed using the method described herein may be solely water resistant, solely water impermeable, solely oil resistant, solely oil impermeable, solely gas resistant, solely gas impermeable, or any combination of water, oil, or gas resistance and/or impermeability. Resistance and/or impermeability to water, oil, and/or gas may also provide a product with increased tensile strength, dimensional stability, improved smoothness, any combination thereof, or the like. The inventor of the present invention has also appreciated that the method of the present invention may be used to immobilise a dye or a pigment such that that the water, oil, and/or gas resistant and/or impermeable product is a coloured product. The inventor of the present invention has yet further appreciated that the method of the present invention may be used to form an antimicrobial and/or ultraviolent light (UV) resistant product.

According to one aspect of the invention, there is provided a method for forming a water, oil, and/or gas resistant and/or impermeable product, the method comprising:
(a) coating a product with a composition, the composition comprising:
   a protein, wherein the protein is a plant-derived protein, an animal-derived protein, a fungus-derived protein, or any combination thereof; and/or
   shellac; and
(b) heating the coated product to form a water, oil, and/or gas resistant and/or impermeable product.

### BRIEF DESCRIPTION OF THE DRAWINGS

Embodiments of the present invention will now be described with reference to the following drawings, in which:

FIG. 1 shows a method (100) for forming a water, oil, and/or gas resistant and/or impermeable product.

### DETAILED DESCRIPTION

The method of the present invention may be used with products comprising a cellulose-based product such as a paper-, cardboard- or wood-based product. Hence, the method of the present invention is suitable for forming water, oil, and/or gas resistant and/or impermeable products comprising a cellulose-based product such as a paper-, cardboard- or wood-based product. The water, oil, and/or gas resistant and/or impermeable paper-, cardboard- or wood-based products formed in accordance with the method of the present invention are biodegradable and/or compostable such that they may be disposed of with normal household waste without contributing to plastic or microplastic pollution.

The composition used in the method of the present invention includes a protein and/or shellac. The protein used in the method of the present invention, where present, may comprise a plant-derived protein, optionally wherein the plant-derived protein comprises a prolamine protein. The protein may comprise vegetable protein, nut protein, seed protein, legume protein, bean protein, pulse protein, grass protein, or any combination thereof. The protein may comprise corn protein, pea protein, soy protein, oat protein, chickpea protein, wheat protein, barley protein, rye protein, sorghum protein, or any combination thereof. The protein may comprise corn protein, optionally wherein the corn protein is zein protein. The protein may comprise an animal-derived protein, optionally wherein the protein is a dairy protein, egg protein, poultry protein, livestock protein, or any combination thereof. The protein may comprise whey protein. The protein may comprise a fungus-derived protein, optionally wherein the protein is a chytridiomycota protein, a zygomycota protein, a glomeromycota protein, an ascomycota protein, a basidiomycota protein, or any combination thereof.

Shellac, where present, refers to the resin produced by the lac bug which is typically found in the forests of India and Thailand.

The composition may not comprise shellac. More particularly, the composition may comprise a protein and be free, or substantially free, of shellac. Alternatively, the composition may not comprise a protein. More particularly, the composition may comprise shellac and be free, or substantially free, of protein. For the avoidance of doubt, the term ‘substantially free’ as used herein may refer to the presence of almost 0% of a substance aside from minor contamination or unavoidable residual trace amounts present in a product or composition. For example, a product or composition that is ‘substantially free’ of a material may have about 0%, less than about 0.1%, less than about 0.2%, less than about 0.3%, less than about 0.4%, or less than about 0.5% of the material.

The composition may comprise a solvent. A solvent may be introduced or applied to the coating and/or product during the method. The solvent may comprise water, one or more alcohols, carboxylic acids, and/or any combination thereof. Optionally the solvent may comprise water, methanol, ethanol, isopropanol, butanol, ethylene glycol, methanoic acid (formic acid), ethanoic acid (acetic acid), propanoic acid, or any combination thereof. The protein and/or shellac may be dissolved and/or dispersed in the solvent, where present. The protein and/or shellac may be used in the method of the present invention in the form of a solid. The solid form may be a solid powder. The solid may be a sheet, layer, or the like. The solid may be discreet particles of various sizes including at least some larger than a powder. Where the protein and/or shellac are used in the form of a solid, the method may exclude the use of a solvent. Alternatively, a solvent may be used in one or more of the method steps before, after, or during the use of a solid protein and/or shellac.

The solvent, where present, may be a combination of solvents. Where the solvent is a combination of solvents, the solvent may comprise a first solvent and second solvent in a ratio of first solvent to second solvent by either volume of solvent or by mass of solvent. For example, the ratio of first solvent to second solvent may be about 5:95, about 10:90, about 15:85, about 20:80, about 25:75, about 30:70, about 35:65, about 40:60, about 45:55, about 50:50, about 55:45, about 60:40, about 65:35, about 70:30, about 75:25, about 80:20, about 85:15, about 90:10, or about 95:5. In particular examples of solvents containing alcohols, the solvent may include 50% alcohol and 50% water, 60% alcohol and 40% water, 70% alcohol and 30% water, or 80% alcohol and 20% water. In examples where the solvent includes a carboxylic acid, the solvent may include 50% carboxylic acid and 50% water, 60% carboxylic acid and 40% water, 70% carboxylic acid and 30% water, or 80% carboxylic acid and 20% water.

In accordance with the method of the present invention, the product may be coated with the composition by spraying the composition onto the product, soaking the product in the composition, dipping the product in the composition, roller coating the composition onto the product, brushing the composition onto the product, wiping the composition onto the product, impregnating the product with the composition by padding, exhausting the composition on the product, flowing the composition onto the product, the use of slit coating techniques, the use of blade application techniques, or any combination thereof. The skilled person, with the benefit of this disclosure, will be able to identify a suitable technique for coating a product depending upon the form and physiochemical properties of the composition to be used and the product to be coated.

The product may be coated by more than one coating technique, and/or may be coated more than once. Where a coating is applied to the product more than once, the coating techniques used for each coating process may be the same or may be different. For example, the product may be first sprayed with the composition before subsequently being dipped in the composition. Alternatively, the product may be dipped in the composition two distinct times to apply the coating. Where more than one coating process, technique, or method step is used then the coating processes may occur in succession and therefore be performed in immediate succession without interruption. Additionally, or alternatively, any two coating processes may be separated by one or more other process such as drying, heating, or any other method or process as substantially described herein.

A portion of the coating, or ‘excess’ coating, may be removed from the product following application of the coating to the product. The portion of the coating, or excess coating, may be removed by any suitable technique. Suitable techniques include, but are not limited to, dabbing, blotting, flow under gravity, vibrational techniques, shaking, screening, blading, shaving, grinding, air-based techniques such as the use of air knives, application of further solvent, etching, or any combination thereof. A portion of the coating or excess coating may be removed to provide a thinner or more even thickness of coating upon a surface or the surface of the product. The thickness of the coating may alter the properties and characteristics of the coating and/or the product once the water, oil, and/or gas resistant and/or impermeable product has been formed. The portion of the coating, or excess coating, may be removed at any suitable point in the method. For example, the portion of the coating or excess coating may be removed after application of the coating to the product. If the coating is a liquid, or semi-liquid, when the coating is removed then techniques that are effective upon a liquid such as dabbing, blotting, flow, and others may be most suitable. If the coating is a solid or partial solid when the coating is removed then techniques that are effective upon a solid such as blading, shaving, grinding, etching, or others may be most suitable. In methods where a portion of the coating or excess coating is removed from the product, such coating may be removed before, after, or both before and after the product is heated to form the water, oil, and/or gas resistant and/or impermeable product.

The temperature to which the coated product is heated will depend upon the thermal characteristics and behaviour of the composition and/or the material from which the coated product is formed. However, the inventor has found that, very surprisingly, the coated product may be heated to temperatures in excess of the ignition temperature of the uncoated product and/or in excess of the thermal degradation temperature of the protein and/or shellac. For example, a coated product (including a coated cellulose-based product such as a paper-, cardboard- or wood-based product) may be heated to temperatures between 200° C. and 300° C. without damaging the coated product via ignition or thermal degradation. In some examples, coated products including cardboard or wood-based products can be heated to even higher temperatures of 300° C. to 500° C. or more without ignition or thermal degradation of the product. Therefore, a coated product may be heated to temperatures of 200° C. to 500° C., or more, without ignition or thermal degradation. Without wishing to be bound by theory, it is thought that heating the coated product results in the loss of hydroxyl groups at the surface of the coated product, which enables the composition to interact with the surface of the product to cause formation of a water, oil, and/or gas resistant and/or impermeable product.

Optionally the coated product may be heated to a temperature of approximately 200° C., approximately 205° C., approximately 210° C., approximately 215° C., approximately 220° C., approximately 225° C., approximately 230° C., approximately 235° C., approximately 240° C., approximately 245° C. approximately 250° C., approximately 255° C. approximately 260° C., approximately 265° C., approximately 270° C., approximately 275° C., approximately 280° C., approximately 285° C., approximately 290° C., approximately 295° C., approximately 300° C., approximately 305° C., approximately 310° C., approximately 315° C., approximately 320° C., approximately 325° C., approximately 330° C., approximately 335° C., approximately 340° C., approximately 345° C. approximately 350° C., approximately 355° C. approximately 360° C., approximately 365° C., approximately 370° C., approximately 375° C., approximately 380° C., approximately 385° C., approximately 390° C., approximately 395° C., approximately 400° C., approximately 405° C., approximately 410° C., approximately 415° C., approximately 420° C., approximately 425° C., approximately 430° C., approximately 435° C., approximately 440° C., approximately 445° C. approximately 450° C., approximately 455° C. approximately 460° C., approximately 465° C., approximately 470° C., approximately 475° C., approximately 480° C., approximately 485° C., approximately 490° C., approximately 495° C., or approximately 500° C. Optionally the coated product may be heated to a temperature of above 200° C., above 205° C., above 210° C., above 215° C., above 220° C., above 225° C., above 230° C., above 235° C., above 240° C., above 245° C. above 250° C., above 255° C. above 260° C., above 265° C., above 270° C., above 275° C., above 280° C., above 285° C., above 290° C., above 295° C. or above 300° C. Optionally, the coated product may be heated to a temperature of 200° C. to 300° C., 200° C. to 290° C., 200° C. to 280° C., 200° C. to 270° C., 200° C. to 260° C., 200° C. to 250° C., 200° C. to 240° C., 200° C. to 230° C., 200° C. to 220° C., 200° C. to 210° C., 210° C. to 300° C., 210° C. to 290° C., 210° C. to 280° C., 210° C. to 270° C., 210° C. to 260° C., 210° C. to 250° C., 210° C. to 240° C., 210° C. to 230° C., 210° C. to 220° C., 220° C. to 300° C., 220° C. to 290° C., 220° C. to 280° C., 220° C. to 270° C., 220° C. to 260° C., 220° C. to 250° C., 220° C. to 240° C., 220° C. to 230° C., 230° C. to 300° C., 230° C. to 290° C., 230° C. to 280° C., 230° C. to 270° C., 230° C. to 260° C., 230° C. to 250° C., 230° C. to 240° C., 240° C. to 300° C., 240° C. to 290° C., 240° C. to 280° C., 240° C. to 270° C., 240° C. to 260° C., 240° C. to 250° C., 260° C. to 300° C., 260° C. to 290° C., 260° C. to 280° C., 260° C. to 270° C., 270° C. to 300° C., 270° C. to 290° C., 270° C. to 280° C., 280° C. to 300° C., 280° C. to 290° C., or 290° C. to 300° C. It may be advantageous to heat the product to a temperature at or in excess of 240° C. For example, 240° C., 245° C. or 250° C. may be particularly advantageous.

The period of time for which the coated product is heated may depend upon the shape, thickness, dimensions, or spatial topography of the product. The period of time for which the coated product is heated may also depend upon the method, process, or apparatus by which the coated produced is heated. The period of time for which the coated product is heated may additionally, or alternatively, depend upon the composition and/or the material from which the coated product is formed. The coated product may be heated for a period of less than 1 minute, from 1 minute to 1 hour, from 5 minutes to 1 hour, or optionally for approximately 1 minute, approximately 2 minutes, approximately 3 minutes, approximately 4 minutes, approximately 5 minutes, approximately 6 minutes, approximately 7 minutes, approximately 8 minutes, approximately 9 minutes, approximately 10 minutes, approximately 15 minutes, approximately 20 minutes, approximately 25 minutes, approximately 30 minutes, approximately 35 minutes, approximately 40 minutes, approximately 45 minutes, approximately 50 minutes, approximately 55 minutes or approximately 1 hour. In some circumstances, for example where a product is large or where a large amount of composition is to be used, a heating time in excess of 1 hour may be appropriate. For example, approximately 1 hour and 5 minutes, approximately 1 hour and 10 minutes, approximately 1 hour and 15 minutes, approximately 1 hour and 20 minutes, approximately 1 hour and 25 minutes, approximately 1 hour and 30 minutes, approximately 1 hour and 35 minutes, approximately 1 hour and 40 minutes, approximately 1 hour and 45 minutes, approximately 1 hour and 50 minutes, approximately 1 hour and 55 minutes or approximately 2 hours. In some circumstances, for example where a product is small, where a product has a large exposed surface area, where only a small amount of composition is to be used, or where a large amount of thermal energy is delivered to a product in a short space of time, then a heating time of, or under, 15 minutes may be appropriate. In particular applications where the product is exposed to a high amount and/or intensity of thermal energy in a short amount of time, then it may be advantageous to heat the coated product for only a short period of time such as approximately 5 seconds, approximately 6 seconds, approximately 7 seconds, approximately 8 seconds, approximately 9 seconds, approximately 10 seconds, approximately 11 seconds, approximately 12 seconds, approximately 13 seconds, approximately 14 seconds, approximately 15 seconds, approximately 16 seconds, approximately 17 seconds, approximately 18 seconds, approximately 19 seconds, approximately 20 seconds, approximately 25 seconds, approximately 30 seconds, approximately 35 seconds, approximately 40 seconds, approximately 45 seconds, approximately 50 seconds, approximately 55 seconds, approximately 60 seconds, approximately 1 minute, approximately 2 minutes, approximately 3 minutes, approximately 4 minutes, approximately 5 minutes, approximately 6 minutes, approximately 7 minutes, approximately 8 minutes, approximately 9 minutes, approximately 10 minutes, or approximately 15 minutes.

The period of time for which the coated product is heated may be up to 5 seconds, up to 6 seconds, up to 7 seconds, up to 8 seconds, up to 9 seconds, up to 10 seconds, up to 11 seconds, up to 12 seconds, up to 13 seconds, up to 14 seconds, up to 15 seconds, up to 16 seconds, up to 17 seconds, up to 18 seconds, up to 19 seconds, up to 20 seconds, up to 25 seconds, up to 30 seconds, up to 35 seconds, up to 40 seconds, up to 45 seconds, up to 50 seconds, up to 55 seconds, up to 1 minute, up to 2 minutes, up to 3 minutes, up to 4 minutes, up to 5 minutes, up to 6 minutes, up to 7 minutes, up to 8 minutes, up to 9 minutes, up to 10 minutes, up to 15 minutes, up to 20 minutes, up to 25 minutes, up to 30 minutes, up to 35 minutes, up to 40 minutes, up to 45 minutes, up to 50 minutes, up to 55 minutes or up to 1 hour. The period of time for which the coated product is heated may be 0 minutes to 1 hour, 1 minute to 1 hour, 5 minutes to 1 hour, 10 minutes to 1 hour, 15 minutes to 1 hour, 20 minutes to 1 hour, 25 minutes to 1 hour, 30 minutes to 1 hour, 35 minutes to 1 hour, 40 minutes to 1 hour, 45 minutes to 1 hour, 50 minutes to 1 hour, 55 minutes to 1 hour, 5 minutes to 55 minutes, 10 minutes to 55 minutes, 15 minutes to 55 minutes, 20 minutes to 55 minutes, 25 minutes to 55 minutes, 30 minutes to 55 minutes, 35 minutes to 55 minutes, 40 minutes to 55 minutes, 45 minutes to 55 minutes, 50 minutes to 55 minutes, 5 minutes to 50 minutes, 10 minutes to 50 minutes, 15 minutes to 50 minutes, 20 minutes to 50 minutes, 25 minutes to 50 minutes, 30 minutes to 50 minutes, 35 minutes to 50 minutes, 40 minutes to 50 minutes, 45 minutes to 50 minutes, 5 minutes to 45 minutes, 10 minutes to 45 minutes, 15 minutes to 45 minutes, 20 minutes to 45 minutes, 25 minutes to 45 minutes, 30 minutes to 45 minutes, 35 minutes to 45 minutes, 40 minutes to 45 minutes, 5 minutes to 40 minutes, 10 minutes to 40 minutes, 15 minutes to 40 minutes, 20 minutes to 40 minutes, 25 minutes to 40 minutes, 30 minutes to 40 minutes, 35 minutes to 40 minutes, 5 minutes to 35 minutes, 10 minutes to 35 minutes, 15 minutes to 35 minutes, 20 minutes to 35 minutes, 25 minutes to 35 minutes, 30 minutes to 35 minutes, 5 minutes to 30 minutes, 10 minutes to 30 minutes, 15 minutes to 30 minutes, 20 minutes to 30 minutes, 25 minutes to 30 minutes, 5 minutes to 25 minutes, 10 minutes to 25 minutes, 15 minutes to 25 minutes, 20 minutes to 25 minutes, 5 minutes to 20 minutes, 10 minutes to 20 minutes, 15 minutes to 20 minutes, 5 minutes to 15 minutes, 10 minutes to 15 minutes, or 5 minutes to 10 minutes.

Heating the coated product may comprise heating the coated product to a first temperature for a first period of time, then heating the coated product to a second temperature for a second period of time. The first temperature may be higher than or lower than the second temperature. The first period of time may be longer than, equal to or shorter than the second period of time. In the interests of conciseness, the first period and/or the second period may be any period of time disclosed herein in respect of heating timing or duration. For example, the first period may be for a period of from less than 1 minute to 1 hour, optionally for approximately 1 minute, approximately 5 minutes, approximately 10 minutes, approximately 15 minutes, approximately 20 minutes, approximately 25 minutes, approximately 30 minutes, approximately 35 minutes, approximately 40 minutes, approximately 45 minutes, approximately 50 minutes, approximately 55 minutes or approximately 1 hour. The second period may be for a period of from less than 1 minute to 1 hour, optionally for approximately 1 minute, approximately 5 minutes, approximately 10 minutes, approximately 15 minutes, approximately 20 minutes, approximately 25 minutes, approximately 30 minutes, approximately 35 minutes, approximately 40 minutes, approximately 45 minutes, approximately 50 minutes, approximately 55 minutes or approximately 1 hour. The temperature to which the product is heated in the first period may be up to 5° C., 10° C., 15° C., 20° C., 25° C., 30° C., 35° C., 40° C., 45° C., 50° C., or more than 50° C. different to the temperature to which the product is heated in the second period. For example, the product may be heated to a temperature of 200° C. in the first period and then to a temperature of 250° C. in the second period. In another example, the product may be heated to a temperature of 300° C. in the first period and a temperature of 280° C. in the second period. In other examples, the temperature in the first period may be 225° C. with a temperature in the second period of 240° C., 245° C., 250° C., 255° C., or 260° C.

The apparatus used to heat the coated product in the method may be any suitable form of heating apparatus. In one example, the apparatus may be a heated press-type apparatus. Where a heated press is used, the heated press may be a flat press or a shaped press depending on the desired shape and characteristics of the product. In one example, the apparatus may be a conventional oven type apparatus. In such examples, the heat and/or thermal energy may be provided via a heat source including one or more gas burners, oil burners, electrically heated filaments, any combination thereof, or the like. Additionally, or alternatively, the apparatus may include a heat source of one or more infra-red (IR) heating devices such as an IR lamp. Some heating apparatus or heating methods may be more suitable for some particular product types than other heating methods. For example, a heated press apparatus may be preferred for some products with a sheet configuration such as paper sheets, cardboard sheets, or wooden boards. Infra-red heating may be preferred for products with a greater product thickness such as wooden planks or cardboard structures. However, for the avoidance of doubt, any suitable heating apparatus may be used to heat any suitable product.

Where multiple heat sources or heating apparatus are used to heat the product then each heat source and/or heating apparatus of the one or more heating apparatus may be the same, or different, as one or more other heart sources and/or heating apparatus of the one or more heating apparatus. For example, where two heat sources are used then the first source of heat may be an electric heated filament and the second source of heat may be an IR heater. In another example where two heat sources are used then both heat sources may be an IR heater with each having a different energy rating and/or providing a different wavelength of infra-red radiation. For example, an IR heater may irradiate a sample with short and/or long wavelength infra-red radiation. Short wavelength infra-red radiation may be in a wavelength range of about 700 nm to about 500000 nm. Long wavelength infra-red radiation may be in a wavelength range of about 500000 nm to about 1 mm. The energy rating of the, one, or each, IR heater may be rated at about 1.0 kW, about 1.2 kW, about 1.4 kW, about 1.6 kW, about 1.8 kW, about 2.0 kW, about 2.2 kW, about 2.4 kW, about 2.6 kW, about 2.8 kW, about 3.0 kW, about 3.2 kW, about 3.4 kW, about 3.6 kW, about 3.8 kW, about 4.0 kW, about 4.2 kW, about 4.4 kW, about 4.6 kW, about 4.8 kW, about 5.0 kW, about 5.2 kW, about 5.4 kW, about 5.6 kW, about 5.8 kW, about 6.0 kW, about 6.2 kW, about 6.4 kW, about 6.6 kW, about 6.8 kW, about 6.0 kW, about 6.2 kW, about 6.4 kW, about 6.6 kW, about 6.8 kW, about 7.0 kW, about 7.2 kW, about 7.4 kW, about 7.6 kW, about 7.8 kW, about 8.0 kW, about 8.2 kW, about 8.4 kW, about 8.6 kW, about 8.8 kW, about 9.0 kW, about 9.2 kW, about 9.4 kW, about 9.6 kW, about 9.8 kW, or about 10.0 kW, In one particular example, four IR lamps rated at 9 kW may be used to heat the product. In another particular examples, a single IR lamp rated at 1.2 kW may be used to heat the product. In a further particular example, a single IR lamp rated at 9 kW may be used to heat the product. In a yet further example, two IR lamps rated at 1 kW may be used to heat the product. In another yet further example, an IR lamp rated at 1.2 kW may be used to heat the product followed by four IR lamps rated at 9 kW.

The method may be any suitable type of method. For example, the method may be a batch method, a semi-batch method, or a continuous method. In one example, the method may be a batch method and the coated product or products may be placed stationary in an oven in fixed numbers and heated before being subsequently removed. In another example, the method may be a continuous method and the coated products may pass through an oven on a conveyor or similar system while further coated products are formed and fed to the oven via the conveyor or similar system over a period of time. Batch, semi-batch, or continuous methodologies may be combined with any type of heating apparatus or heating method described herein. For example, a batch process may use an infra-red oven to heat the product. Alternatively, a batch process might use a gas-heated chamber to heat the product. Alternatively, the product(s) may be passed to a conveyor system which will cause them to pass through an infra-red heating apparatus in a continuous manner.

The method may include one or more drying processes. The product may be dried prior to the coating of the product with the composition. The product may be air dried, dried at a temperature, or dried by any other suitable method. In one example, the product may be air dried for a period of 12 hours, 24 hours, or any other suitable period of time prior to application of the composition to the product. In another example, the product may be dried in an oven at 50° C., 60° C., 70° C., 80° C., 90° C., 100° C., or any other suitable temperature for a period of 5 minutes, 10 minutes, 15 minutes, 20 minutes, 30 minutes, 40 minutes, 50 minutes, 60 minutes, 90 minutes, 120 minutes, 150 minutes, 180 minutes, 240 minutes, 300 minutes, or any other suitable period of time. In examples where the composition includes a solvent, the coated product may be dried prior to heating. The coated product may be air dried, dried at a temperature, or dried by any other suitable method. In one example, the coated product may be air dried for a period of 12 hours, 24 hours, or any other suitable period of time prior to heating the coated product. In another example, the coated product may be dried in an oven at 50° C., 60° C., 70° C., 80° C., 90° C., 100° C., or any other suitable temperature for a period of 5 minutes, 10 minutes, 15 minutes, 20 minutes, 30 minutes, 40 minutes, 50 minutes, 60 minutes, 90 minutes, 120 minutes, 150 minutes, 180 minutes, 240 minutes, 300 minutes, or any other suitable period of time prior to further heating of the coated product.

The method may include storing the product for a period of time. The storing may occur at any point after the product has been coated. For example, the storing may occur after the coating. The storing may occur after the heating. In methods where the product is dried, the storing may occur after the drying. In one example, a product may be coated and then dried prior to storing. After storing, the coated product may be heated as described herein to form a water, oil, and/or gas impermeable product. Where the product is stored, it may be stored for a period of about 5 minutes, about 10 minutes, about 15 minutes, about 30 minutes, about an hour, about 2 hours, about 5 hours, about 12 hours, about 24 hours, about 2 days, about 1 week, about two weeks, about a month, about two months, about 6 months, about a year, or any other suitable period of time. The product may therefore be stored for a period of up to 5 minutes, up to 10 minutes, up to 15 minutes, up to 30 minutes, up to an hour, up to 2 hours, up to 5 hours, up to 12 hours, up to 24 hours, up to 2 days, up to 1 week, up to two weeks, up to a month, up to two months, up to 6 months, up to a year, or more than 1 year. The inventor of the present invention has surprisingly found that products coated with the compositions described herein may be optionally dried and then stored prior to heating without compromising the water, oil, and/or gas resistance and/or impermeability that would be achieved if the product was coated and heated without an intermediate optional drying and storing step.

The method may include rotating, flipping, and/or reorienting the product. The rotating, flipping, and/or reorienting the product may be performed during the heating and/or drying parts of the method, where present. The rotating, flipping, and/or reorienting may additionally, or alternatively, be performed between any two method steps where heat is applied to the product. For example, the rotating, flipping, and/or reorienting may be performed between a first heating step and a second heating step. In another example, the rotating, flipping, and/or reorienting may be performed between a heating step and a drying step. The rotating, flipping, and/or reorienting may be performed by any suitable means. For example, the rotating, flipping, and/or reorienting may be performed mechanically whereby the product is moved, guided, and/or mechanically induced to flip, rotate, and/or reorient. Additionally, or alternatively, the rotating, flipping, and/or reorienting may be performed via non-mechanical methods. In one example, air may be used to exert force upon the product to rotate, flip, and/or reorient the product. In examples where the method is carried out via a continuous process, the pathing of the product may result in the product becoming rotated, flipped, and/or reoriented without additional impetus upon the product.

The skilled person, with the benefit of this disclosure and the accompanying examples, will be able to select a suitable heating temperature, heating time, heating method, and accompanying process conditions to prepare a suitable water, oil, and/or gas resistant and/or impermeable product. As noted in respect of the various process conditions described herein, the preferred method and accompanying process conditions for a particular product will depend upon the characteristics of the product and the components of the composition with which the product is to be coated. For example, a product with a low surface area relative to its mass may require heated for a longer period of time than a product which has a larger exposed surface area of a comparable mass. The nature of the material may also influence the preferred characteristics of the methods as a material with a high heat capacity may require to be heated in a higher energy system, or for a longer time period, than a material with a lower heat capacity. In other examples, the type of product, desired throughput of product, or preferred heating condition may determine whether the process is preferably a batch, semi-batch, or continuous process. Where infra-red heating methods are used, the wavelength and energy rating of the IR apparatus may be selected to provide a particular energy flux upon the product in a particular timeframe depending upon the characteristics of the product and/or coating composition.

The inventor of the present invention has appreciated that the methods described herein may have other surprising benefits. The use of infra-read heating methods eliminates the release of tannins from products containing such tannins. Where a product contains tannins, oven heating was shown to release varying levels of tannin when the product was contacted with water or other solvents. Heating via infra-red processes demonstrated no release of tannins in all tested examples as shown later in Examples 8 to 15. Moreover, some compositions demonstrated improved surface texture and/or water, oil, and/or gas resistance and/or impermeability when heated gradually, or via a multiple step heating process as described herein. Without being bound by theory, it is believed that some compositions undergo a form of thermal shock when exposed to a high temperature from a starting temperature of ambient temperature. Exposing the product and coating composition to a lower temperature before then exposing the product and coating to a higher temperature may surprisingly improve the cohesion, smoothness, and/or consistency of the product. It should be noted, however, than some compositions demonstrated comparable surface characteristics when heated via single heating processes when compared to multi-stage heating processes.

The composition used in the method of the present invention may further comprise a functional additive, optionally the functional additive may comprises a dye, a pigment, a pH sensitive material, a temperature sensitive material, a conductive material, a fluorescent material, any other suitable functional additive, or any combination thereof. In one example, the composition may include a pigment. In another example, the composition may include nanocellulose or microcellulose. The use of nanocellulose or microcellulose may improve one or more properties of the coating formed using the method of the present invention. For example, the use of nanocellulose or microcellulose may improve the texture, smoothness, aesthetic appeal, and/or colour intensity of the product. In an example, where the product is an item of cutlery or other culinary utensil, the use of nanocellulose or microcellulose as a functional additive may improve the mouth feel of utensil or cutlery.

In another example, the composition may include a sol as a functional additive. A sol as a functional additive may improve the strength of the coating composition or the water, oil, and/or gas resistance and/or impermeable product. A sol may be formed by dispersing one or more materials of suitably small particle size in a solution. Some sols may further comprise additional components such as a catalyst or functional components. Sols suitable for use in the methods of the present invention will generally comprise at least a functional metal alkoxide and a solvent The term ‘metal alkoxide’ includes alkoxides comprising metals, organically modified alkoxides comprising metals, alkoxides comprising metalloids, and organically modified alkoxides comprising metalloids. The solvent used in the formation of the sol may comprise water, one or more alcohols, any other suitable solvent, or any combination thereof. Where present, the one or more alcohols may comprise methanol, ethanol, butanol, ethylene glycol, isopropanol, any other suitable alcohol, and any combination thereof. The sol may optionally comprise a biopolymer such as a starch-based polymer, hemi-cellulose-based polymer, cellulose based polymer, a lignin-based polymer, any other suitable biopolymer or modified biopolymer, and any combination thereof. The sol may additionally, or alternatively, comprise one or more flours derived from natural materials. The metal alkoxide will generally conform to the general formula M(OR)x or R_{C}-M(OR)ₓ, where “M” denotes any metal forming the metal alkoxide which may hydrolyse in the presence of a suitable solvent. “R” and “R_{C}” denote alkyl radicals of typically 1 to 30 carbon atoms which may take any suitable form such as straight chain, branched, aromatic or complex. “x” will generally equate to the valence of the corresponding metal ion “M”. In an example, R may be a methyl, ethyl, propyl or butyl radical. Where a metal ion “M” has a valency in excess of 1, each R group may be the same. R_{C} denotes any suitable organic group which will form and maintain a covalent bond with the metal “M” following hydrolysis of the alkoxide. In some examples, R and R_{C} may be the same. In other examples, R and R_{C} may be different. Any suitable metal alkoxide may be used. Examples of suitable metal alkoxides include Si(OR)₄, Ti(OR)₄, Al(OR)₃, Zr(OR)₃ and Sn(OR)₄ as well as R_{C}—Si(OR)₃, R_{C}—Ti(OR)₃, R_{C}—Al(OR)₂, R_{C}—Zr(OR)₂ and R_{C}—Sn(OR)₃. In specific examples, R may be the methyl, ethyl, propyl or butyl radical. In some specific examples, R_{C} may be a phenyl group, a cyclopentyl group, or any other suitable organic group capable of maintaining a covalent bond to the metal. The metal of the metal alkoxide may comprise silicon, titanium, aluminium, zirconium, tin, or any other suitable metal. In particular examples, the metal alkoxides may be selected from the group comprising Ti(isopropoxy)₄, Al(isopropoxy)₃, Al(sec-butoxy)₃, Zr(n-butoxy)₄, Zr(n-propoxy)₄, n-propyltriethoxysilane, tetrapropyl orthosilicate, titanium(IV) tert-butoxide, titanium(IV) isopropoxide, triethyloxysilane, methyltriethyloxysilane, triethoxy(octyl)silane, phenyl-triethoxysilane, titanium(iv) ethoxide, triethoxy-silylcyclopentane, (3-glycidyloxypropyl) trimethoxysilane, cyclopentyltriethoxysilane, 3-amino-propyltriethoxysilane, triethoxy-3-(2-imidazolin-1-yl)propylsilane, and any combination thereof. In selected examples, the metal alkoxides may be selected from the group comprising tetraethoxysilane, phenyltriethoxysilane, methyltriethyloxysilane, and any combination thereof. In further selected examples, the metal alkoxides may be selected from the group comprising tetrapropyl orthosilicate, titanium(IV) tert-butoxide, titanium(IV) isopropoxide, triethyloxysilane, methyltriethyloxysilane, triethoxy(octyl)silane, phenyl-triethoxysilane, titanium(iv) ethoxide, triethoxy-silylcyclopentane, (3-glycidyloxypropyl) trimethoxysilane, cyclopentyltriethoxysilane, or any combination thereof. In additional selected examples, the metal alkoxide may be selected from the group comprising Ti(isopropoxy)₄, Al(isopropoxy)₃, Al(sec-butoxy)₃, Zr(n-butoxy)₄, Zr(n-propoxy)₄, and n-propyltriethoxysilane based alkoxides, and any combination thereof.

For the avoidance of doubt, the composition may also not include a sol as described herein. The composition used in the method of the present invention may therefore be free, or substantially free, of sols or sol gels. For example, the composition used in the method of the present invention may not comprise an alkoxide. The composition used in the method of the present invention may not comprise a catalyst, optionally the composition may not comprise an acid and/or may not comprise a base. More particularly: the composition used in the method of the present invention may be free, or substantially free, of alkoxide; the composition used in the method of the present invention may be free, or substantially free, of catalyst; and/or the composition used in the method of the present invention may be free, or substantially free, of acids or bases. The composition may be free of solvent. For example, the composition may be free of water, alcohols, or the like.

In contrast to other compositions used in similar applications, the composition used in the method of the present invention may exclude, not comprise, be free of, or substantially free of one or more substances, molecules, or compounds. The composition used in the method of the present invention may not comprise an ester. The composition used in the method of the present invention may not comprise a glycol and/or may not comprise a polyol. The composition used in the method of the present invention may not comprise a polysaccharide. The composition used in the method of the present invention may not comprise a synthetic polymer. The composition used in the method of the present invention may not comprise plastic. In an example, the composition used in the method of the present invention may exclude polyol fatty acid esters and/or may exclude saccharide fatty acid esters.

The composition may not comprise a stabilizer. In some examples, the composition may not comprise, exclude, be free from, or substantially free from stabilizers such as carboxymethylcellulose, hydroxyethylcellulose, methylcellulose, ethylcellulose, hydroxyethylpropylcellulose, methylhydroxypropylcellulose, carboxymethylhydroxyethyl-cellulose, xanthan gum, guar gum, gum arabic, acaia gum, carrageenan gum, furcellaran gum, ghatti gum, locust bean gum, gum karaya, gum tragacanth, polyacrylates, polyoxyethylene sorbitan mono-oleate sodium lauryl sulfate, cetyltrimethylammonium bromide, magnesium carbonate, magnesium sulfate, magnesium silicate, alkenyl succinic anhydride, alkyl ketene dimer, styrene maleic anhydride, octynl succinic anhydride, rosin, rosin derivatives, styrene acrylic acetates, styrene acrylic emulsions, polyurethane dispersions, wax dispersions, and/or other stabilizers. The composition may not comprise a plasticiser. In some examples, the composition may not comprise, exclude, be free from, or substantially free from plasticisers such as adipates, azelates, citrates, benzoates, ortho-phthalates, terephthalates, sebacates, and trimellitates.

According to a further aspect of the invention, there is provided a water, oil, and/or gas resistant and/or impermeable product formed by the method of the present invention.

The water, oil, and/or gas resistant and/or impermeable products of the present invention may comprise a cellulose-based product such as a paper-, cardboard- or wood-based product.

The water, oil, and/or gas resistant and/or impermeable products of the present invention may be used to form part or all of a container for use in the food and beverages industry, such as cartons for food storage, bags for food storage, oil and grease resistant (OGR) paper, containers for hot or cold drinks, lids for drinks containers, plates, trays and bowls. In addition, the method of the present invention may be used to form water, oil, and/or gas resistant and/or impermeable products that may be used in the preparation or consumption of food, such as an item of cutlery or a cooking utensil. In an example, the products formed by the method of the present invention may be used to form part of or all of a single-use or multi-use packaging item. The water, oil, and/or gas resistant and/or impermeable products of the present invention may be washable in a dishwasher, washing machine or in a similar manner without loss of shape, cohesion, or performance. In further examples, the water, oil, and/or gas resistant and/or impermeable products of the present invention may be washed in a dishwasher, washing machine, or in a similar manner multiple times and still retain their desired functionality. Therefore, although suitable for use in replacing disposable plastic items, the water, oil, and/or gas resistant and/or impermeable products of the present invention are also suitable for re-use.

The methods described herein are not limited to applications in the food and beverage industries. Products treated using the methods described herein may be advantageously applied to any sector or industry in which that products may find use. For example, products formed using the methods described may be used in industries including construction, furniture, shipbuilding, bridges, railroads, tiles and flooring, fencing, decorating, gardening, plywood structures, panelling, cladding, hand tools, artworks, musical instruments, sports equipment, toys, office equipment and stationery, medical devices, any other suitable industry, or the like.

The water, oil, and/or gas resistant and/or impermeable products of the present invention may be formed from functional additives comprising a dye or a pigment such that the products are coloured products.

The water, oil, and/or gas resistant and/or impermeable products of the present invention may have an increased tensile strength relative to the corresponding products which have not been treated using the methods described herein. Additionally, or alternatively, the water, oil, and/or gas resistant and/or impermeable products of the present invention may have increased dimensional stability, increased scratch resistance, improved smoothness, and/or improved antifouling properties when compared to a product that has not been treated using the methods described herein. Their increased resistance to breaking helps make the products of the present invention suitable for re-use.

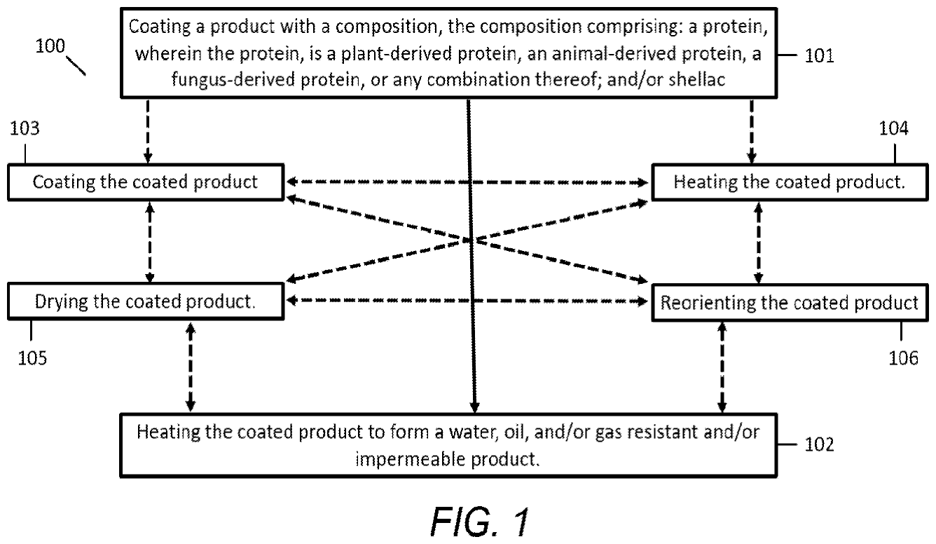

FIG. 1 shows a method (100) for forming a water, oil, and/or gas resistant and/or impermeable product. The method (100) includes coating (101) a product with a composition, the composition comprising: a protein, wherein the protein, is a plant-derived protein, an animal-derived protein, a fungus-derived protein, or any combination thereof; and/or shellac. The method (100) further includes heating (102) the coated product to form a water, oil, and/or gas resistant and/or impermeable product. Optionally, the method (100) may include one or more additional method steps suffice that the method includes the coating (101) and heating (102). The optional method steps are represented as part of the method using broken lines to indicate the optional nature of the related method step. The optional method steps may include: a further coating of the coated product (102); a further heating of the coated product (103); drying the coated product (104); and/or reorienting the coated product (105). Reorienting the product may include flipping or rotating the product as described herein. The optional method steps (103, 104, 105, 106) may be carried out between the coating (101) and the heating (102) and/or may be carried out after the heating (102). The skilled person, with the benefit of this disclosure, will be able to determine suitable optional method steps to achieve desired product characteristics.

### EXAMPLES

### Example 1

An untreated piece of wood was placed in an oven at 200° C. for a period of 10 minutes. After heating, the wood was removed from the oven. The wood exhibited some charring and discoloration. Droplets of water were placed on the surface of the wood and were observed to be absorbed rapidly into the surface. Droplets of oil placed onto the surface of the wood following heating were also observed to be absorbed into the surface structure.

### Example 2

A composition was prepared by mixing 100 ml of ethanol with 10 g of zein corn protein powder. The zein powder was mixed with the solvent. An untreated piece of wood was dipped into the composition, allowed to dry, and then placed in an oven at 240° C. for a period of 10 minutes. After heating, the wood was removed from the oven. The surface of the wood was observed to be smooth in appearance. Droplets of water were placed on the surface of the wood and were allowed to rest upon the surface for a period of 1 hour at which time observations were stopped. The water droplets were retained, unabsorbed upon the surface throughout the entire period of observation. The experiment was repeated with droplets of oil and the droplets of oil were also retained upon the surface of the treated wood.

### Example 3

The experiments carrier out in example 2 were repeated using 20 g, 30 g, and 40 g of zein corn protein powder. The experiments were further repeated using a solvent of 70 wt % ethanol in water. The compositions prepared, and the compositions prepared in example 2, were also diluted in 40 wt % tert-butanol and used as described in example 2. Each wooden sample demonstrated water and/or oil resistance and/or impermeability.

### Example 4

An untreated piece of wood was coated in zein protein powder and the powder was pressed against the wood surface several times. The coated piece of wood was placed in an oven at 250° C. for a period of 8 minutes. After heating, the wood was removed from the oven. The surface of the wood was observed to be smooth in appearance. Droplets of water were placed on the surface of the wood and were allowed to rest upon the surface for a period of 5 minutes at which time observations were stopped. The water droplets were retained unabsorbed upon the surface throughout the entire period of observation. The experiment was repeated with droplets of oil and the droplets of oil were also retained upon the surface of the treated wood.

### Example 5

Shellac was added to the protein compositions prepared in examples 2 and 3 at concentrations of between 5-50 wt % (by weight of solid components). Samples of 20 g shellac in 100 ml of (i) water, (ii) ethanol, and (iii) 70 wt % ethanol and water were also prepared without any protein. Each composition was used to treat a piece of wood and the treated pieces of wood were dried and then heated in an oven at 250° C. for 10 minutes. Once cooled, the treated wood was allowed to cool and water and oil droplets were placed upon the surface of each piece of wood for a period of 10 minutes after which time observations were stopped. None of the treated samples demonstrated absorption of the water or oil droplets.

### Example 6

A composition was prepared by mixing 3 wt % (by total weight of composition) nanocellulose with 100 ml water. An untreated piece of wood was dipped into the composition and placed in an oven at 240° C. for a period of 10 minutes. After heating, the wood was removed from the oven. The surface of the wood was observed to be smooth in appearance. Droplets of water were placed on the surface of the wood and were allowed to rest upon the surface for a period of 1 hour at which time observations were stopped. The water droplets were gradually absorbed into the surface of the wood across the period of observation but at a slower rate than observed for the untreated wood piece of example 1. This shows that nanocellulose alone provides some water resistance but not impermeability as observed in examples 2 and 3. The experiment was repeated with droplets of oil and the droplets of oil were also gradually absorbed into the surface of the treated wood.

### Example 7

Wooden spoons were fully coated in each of the compositions described in examples 2 to 5 and heated in an oven at 250° C. for a period of 10 minutes. The treated spoons were allowed to cool prior to submerging each spoon and an untreated spoon in boiling water for 2 minutes. The untreated wooden spoon was saturated with water, soft, and easily broken by application of minor force. The treated wooden spoons showed no visible absorption of water and retained their strength and dimensional stability following submersion.

### Examples 8 to 15

Wooden spoons were coated with each of the compositions shown in Table 1 in respect of Examples 8 to 15. The compositions included various amounts of zein corn protein in addition to various solvents and, optionally, some sol additives. Two different heating systems were tested. The first system included an infra-red heating apparatus. The compositions heated by the first heating apparatus were processed in conditions representing a continuous processing medium whereby products were coated and moved through the heating apparatus using a solids conveyor system. The IR heating system utilised two 1 kW rated IR lamps. Samples passing through the IR apparatus were heated to at least 240° C. The second heating apparatus tested was a conventional filament heated laboratory oven. Samples were placed in the oven in conditions representing a batch process and were heated to a temperature of between 240° C. and 280° C. Results are presented in Table 1.

All samples of Examples 8 to 15 demonstrated hydrophobicity to varying extents. A sample rated as ‘1’ for hydrophobicity demonstrated a more severe contact angle when droplets of water were placed on the product and/or were observed to allow water to run off of the surface of the product more rapidly than samples rated as ‘2’, and so on down to ‘4’ where the least severe contact angle and/or the slowest flow rate of water was observed. Samples rated as ‘1’ for appearance and/or texture were observed to have a smoother surface and/or more satisfactory mouth feel than samples rated ‘2’ which samples rated ‘4’ having the least smooth and or least satisfactory mouth feel of the samples tested. Surprisingly, samples heated by infra-red heating apparatus showed no subsequent release of tannins from the wooden spoons when the spoons where later dipped into water. Samples heated using the conventional oven did demonstrate some loss of tannins with samples rated ‘2’ releasing fewer tannins than samples rated ‘3’.

### Example 16

Pilot scale infra-red heating apparatus was used to process wooden spoon samples coated with compositions including shellac. The compositions tested were identical to those described above in respect of Examples 8 to 15 except the zein corn protein was replaced with an identical amount of shellac. Conveyor speeds of between 0.8 m/min and 3 m/min were used to heat samples using four 9 kW rated IR lamps and one 1.2 kW rated IR lamp positioned at the beginning of the belt.

The use of all IR heating lamps in the lamp array resulted in poorer hydrophobicity and less desirable textures on the products. The best hydrophobicity and the textures were obtained using slower belt speeds and only some of the IR lamp array to heat the product. Treating the product in a two-stage process using a low energy IR lamp followed by a higher energy proportion of the IR lamp array demonstrated yet further improvements in the hydrophobicity and texture of the end product.

TABLE 1
Experimental results for Examples 8 to 15

| | | Heated with IR | | | | Heated in Oven | | | |
|---|---|---|---|---|---|---|---|---|---|
| | | | Appearance/ | | | | Appearance/ | | |
| Example | Composition | Hydrophobicity | Texture | Tannin | Result | Hydrophobicity | Texture | Tannin | Result |
| 8 | 30 g corn protein | 4 | 3 | Not | Good | N/A | N/A | N/A | N/A |
| | 100 ml 70% EtOH | | | detected | | | | | |
| 9 | 30 g corn protein | 1 | 2 | Not | Best | 1 | 1 | 3 | Better |
| | 100 ml 70% EtOH | | | detected | | | | | |
| | 10 ml sol | | | | | | | | |
| 10 | 24 g corn protein | 4 | 3 | Not | Good | N/A | N/A | N/A | N/A |
| | 80 ml 60% AcOH | | | detected | | | | | |
| 11 | 24 g corn protein | 3 | 2 | Not | Better | 1 | 2 | 2 | Best |
| | 80 ml 60% AcOH | | | detected | | | | | |
| | 10 ml sol | | | | | | | | |
| 12 | 31 g corn protein | 4 | 3 | Not | Good | N/A | 4 | N/A | N/A |
| | 80 ml 60% AcOH | | | detected | | | | | |
| 13 | 31 g corn protein | 2 | 3 | Not | Better | N/A | 4 | N/A | N/A |
| | 80 ml 60% AcOH | | | detected | | | | | |
| | 10 ml sol | | | | | | | | |
| 14 | 31 g corn protein | 2 | 3 | Not | Better | N/A | 3 | N/A | N/A |
| | 80 ml 60% AcOH | | | detected | | | | | |
| | 20 ml sol | | | | | | | | |
| 15 | 30 g corn protein | 2 | 3 | Not | Better | 1 | 1 | 3 | Better |
| | 100 ml 70% EtOH | | | detected | | | | | |
| | 20 ml sol | | | | | | | | |

### Example 17

Paper sheets were dipped in (1) compositions including corn protein; or (2) compositions including shellac. The paper sheets were transferred to a heat press apparatus and pressed at 250° C. for a period of up to 5 seconds. After allowing the paper sheets to cool, the sheets were tested for water and oil permeability. All paper sheet samples demonstrated both water and oil resistance and, in some cases, impermeability. All samples demonstrated improved scratch resistance.

### Example 18

The experiment of Example 17 was repeated but the paper samples were instead left to air dry after being dipped in the protein or shellac compositions. Air dried samples were then stored for periods of (i) a day; (ii) a week; (iii) two weeks; (iv) a month; (v) two months; and (vi) 6 months before being heated in a heat press at 250° C. for a period of up to 10 seconds. The stored and then pressed samples all demonstrated both water and oil resistance with some samples demonstrating impermeability. All samples demonstrated improved scratch resistance.

What is claimed is:

1-34. (canceled)

35. A method for forming a water, oil, and/or gas resistant and/or impermeable product, the method comprising:
(a) coating a product with a composition, the composition comprising:
a protein, wherein the protein, is a plant-derived protein, an animal-derived protein, a fungus-derived protein, or any combination thereof; and/or
shellac; and
(b) heating the coated product to form a water, oil, and/or gas resistant and/or impermeable product.

36. The method according to claim 35, wherein the product comprises a cellulose-based product such as a paper-, cardboard- or wood-based product.

37. The method according to claim 35, wherein the composition comprises a solvent, optionally wherein the solvent comprises water, one or more carboxylic acids, one or more alcohols, and/or any combination thereof, optionally wherein the solvent comprises water, methanol, ethanol, isopropanol, butanol, ethylene glycol, methanoic acid, ethanoic acid, propanoic acid, or any combination thereof.

38. The method according to claim 35, wherein the composition comprises a protein, and the protein comprises a plant-derived protein, optionally wherein the plant-derived protein comprises a prolamine protein.

39. The method according to claim 38, wherein the protein comprises vegetable protein, nut protein, seed protein, legume protein, bean protein, pulse protein, grass protein, or any combination thereof, optionally wherein the protein comprises corn protein, pea protein, soy protein, oat protein, chickpea protein, wheat protein, barley protein, rye protein, sorghum protein, or any combination thereof, optionally wherein the protein comprises corn protein, optionally wherein the corn protein is zein protein.

40. The method according to claim 35, wherein the composition comprises a protein, and the protein comprises an animal-derived protein, optionally wherein the protein is a dairy protein, egg protein, poultry protein, livestock protein, or any combination thereof, optionally wherein the protein comprises whey protein.

41. A method according to claim 35, wherein the composition comprises a protein, and the protein comprises a fungus-derived protein, optionally wherein the protein is a chytridiomycota protein, a zygomycota protein, a glomeromycota protein, an ascomycota protein, a basidiomycota protein, or any combination thereof.

42. The method according to claim 35, wherein
a. the composition comprises a protein and does not comprise shellac; or
b. the composition comprises shellac and does not comprise a protein.

43. The method according to claim 35, wherein the product is coated with the composition by spraying the composition onto the product, soaking the product in the composition, dipping the product in the composition, roller coating the composition onto the product, brushing the composition onto the product, wiping the composition onto the product, impregnating the product with the composition by padding, exhausting the composition on the product, flowing the composition onto the product, the use of slit coating techniques, the use of blade application techniques, or any combination thereof.

44. The method according to claim 35, wherein heating the coated product to form a water, oil, and/or gas resistant and/or impermeable product is carried out using:
one or more gas burners, oil burners, electrically heated filaments, any combination thereof; and/or
one or more infra-red (IR) heating devices.

45. A method according to claim 35, wherein
a. heating the coated product comprises heating to a temperature between 200° C. and 500° C., optionally to a temperature of approximately 200° C., approximately 210° C., approximately 220° C., approximately 230° C., approximately 240° C., approximately 250° C., approximately 260° C., approximately 270° C., approximately 280° C., approximately 290° C. or approximately 300° C.; and/or
b. heating the coated product comprises heating for a period of from 5 seconds to 1 hour, optionally for approximately 5 seconds, approximately 6 seconds, approximately 7 seconds, approximately 8 seconds, approximately 9 seconds, approximately 10 seconds, approximately 11 seconds, approximately 12 seconds, approximately 13 seconds, approximately 14 seconds, approximately 15 seconds, approximately 16 seconds, approximately 17 seconds, approximately 18 seconds, approximately 19 seconds, approximately 20 seconds, approximately 25 seconds, approximately 30 seconds, approximately 35 seconds, approximately 40 seconds, approximately 45 seconds, approximately 50 seconds, approximately 55 seconds, approximately 60 seconds, approximately 1 minute, approximately 2 minutes, approximately 3 minutes, approximately 4 minutes, approximately 5 minutes, approximately 10 minutes, approximately 15 minutes, approximately 20 minutes, approximately 25 minutes, approximately 30 minutes, approximately 35 minutes, approximately 40 minutes, approximately 45 minutes, approximately 50 minutes, approximately 55 minutes or approximately 1 hour.

46. A method according to claim 35, wherein heating the coated product comprises heating the coated product comprises heating to a first temperature for a first period of time, then heating the coated product to a second temperature for a second period of time.

47. A method according to claim 46, wherein
a. the first temperature is higher than or lower than the second temperature, optionally wherein the temperature to which the product is heated in the first period is or is up to, 5° C., 10° C., 15° C., 20° C., 25° C., 30° C., 35° C., 40° C., 45° C., 50° C., or more than 50° C., different to the temperature to which the product is heated in the second period; and/or
b. the first period of time is longer than, equal to or shorter than the second period of time.

48. A method according to claim 35, wherein the composition further comprises a functional additive, optionally wherein the functional additive comprises a dye, a pigment, a pH sensitive material, a temperature sensitive material, a conductive material, a fluorescent material, a sol comprising an alkoxide and a solvent, or combinations thereof, optionally wherein the functional additive comprises nanocellulose or microcellulose.

49. A method according to claim 35, wherein
a. the composition does not comprise an alkoxide; and/or
b. the composition does not comprise a catalyst, optionally wherein the composition does not comprise an acid and/or does not comprise a base; and/or
c. the composition does not comprise an ester; and/or
d. the composition does not comprise a glycol and/or does not comprise a polyol; and/or
e. the composition does not comprise a polysaccharide; and/or
f. the composition does not comprise a synthetic polymer; and/or
g. the composition does not comprise a sol and/or a sol gel; and/or
h. the composition does not comprise a stabiliser; and/or
i. the composition does not comprise a plasticiser.

50. A water, oil, and/or gas resistant and/or impermeable product formed by a method according to claim 35.

51. The product according to claim 50, wherein product comprises a cellulose-based product such as a paper-, cardboard- or wood-based product.

52. The product according to claim 51, wherein
a. the product forms part or all of a container for use in the food and beverages industry, optionally wherein the product forms a lid; or
b. the product is an item of cutlery or a cooking utensil.

53. The product according to claim 50, wherein the product is a coloured product.

54. The product according to claim 51, wherein the product has an increased tensile strength, increased dimensional stability, increased scratch resistance, improved smoothness, and/or improved antifouling properties relative to a corresponding uncoated product.
